(19) United States
(12) Patent Application Publication
(10) Pub. No.: US 2011/0280435 A1
(43) Pub. Date: Nov. 17, 2011

(54) IMAGE PROCESSING APPARATUS

(75) Inventor: Tetsuroh Chiba, Osaka (JP)

(73) Assignee: SHARP KABUSHIKI KAISHA, Osaka (JP)

(21) Appl. No.: 13/106,409

(22) Filed: May 12, 2011

(30) Foreign Application Priority Data
May 12, 2010 (JP) 2010-109886

(51) Int. Cl. G06K 9/00

(52) U.S. Cl. 382/100

(57) ABSTRACT

The image processing apparatus is provided with a user authenticating portion, an operation portion capable of displaying an operation screen, and a registration portion for registering in a storage portion, with respect to an operation screen of the image processing function displayed through inputting of a user operation, the operation screen and a numeric key input before or after user authentication processing by the user authenticating portion being associated with each other for each authenticated user. The image processing apparatus, when the user authentication processing and inputting of the numeric key are performed, displays the operation screen, or a screen during image processing or after image processing as well as executes image processing by the image processing function.

### CROSS-NOTING PARAGRAPH

This non-provisional application claims priority under 35 U.S.C. §119 (a) on Patent Application No. 2010-109886 filed in JAPAN on May 12, 2010, the entire contents of which are hereby incorporated herein by reference.

### FIELD OF THE INVENTION

The present invention relates to an image processing apparatus having a plurality of image processing functions and capable of carrying out user authentication.

### BACKGROUND OF THE INVENTION

An image processing apparatus including an image forming apparatus such as a copier or a facsimile apparatus has a lot of functions for user convenience and has the increased number of operation screens (screens for setting image processing conditions) accordingly. Thus, for the purpose of improving easiness when a user selects one desired operation screen among a lot of operation screens, the image processing apparatus is configured to reach the operation screen desired by the user via an intermediate selection screen from an initial operation screen.

Therefore, the number of operations by the user is increased until reaching the operation screen for desired setting. This tendency is further increased in a multi-functional peripheral having at least two functions of a copy function, a facsimile function, a scan function and a printer function. Moreover, in the case of a user with much knowledge and the case of using a specific function that is used frequently, the increased number of operations is cumbersome for the user.

In view of such a situation, an image processing apparatus has been proposed that, an directly display a desired operation screen with one touch of a button by skipping intervening screens so as to display the desired operation screen to a user with much knowledge with a small number of operations.

For example, an image forming apparatus described in Japanese Laid-Open Patent Publication No, 2009-284213, registers a plurality of shortcut keys (soft keys) in advance for each user, and when user authentication is carried out by touching with an IC (Integrated Circuit) card at the time of displaying an initial operation screen, selects any of a plurality of the shortcut keys for the authenticated user depending on the multiple number of touches of the IC card or the touch time of the IC card and displays a target operation screen by skipping intervening screens.

Moreover, an image forming apparatus described in Japanese Laid-Open Patent Publication No. 2002-354170, displays a shortcut key (soft key) in each operation screen including an initial operation screen and displays a desired operation screen with the operation of the shortcut key by skipping intervening operation screens.

In addition, like the image forming apparatus described in Japanese Laid-Open Patent Publication No. 2009-284213, more digital multi-functional peripherals recently have a user authentication system by an IC card, biometric authentication and the like, and it is considered that more and more companies will introduce an authentication system at the time of purchase from now on in order to emphasize security and establish a device management system such as grasping of the situation of use.

In the case of a multi-functional peripheral using the user authentication system, a log-in operation is generally carried out when an initial screen is displayed and a desired image processing function is selected from a function selection screen (menu screen) to move to the initial operation screen and make operation setting, followed by execution of printing and the like.

FIG. 18 is a conceptual diagram to explain the processing for moving to an initial operation screen of a desired image processing function in an image forming apparatus with an authentication function by a conventional technology. First, in an image forming apparatus 90, when a user presses a shortcut key by a hard key 91 and thereafter carries out user authentication (authentication log-in) by an ID card, biometric authentication with finger prints or the like, a function selection screen 92 is not displayed as the initial operation screen but a desired operation screen registered to be associated with the shortcut key in advance by the user can be displayed. For example, when registration is carried out such that shortcut keys 0, 1, 2 and 3 are associated with a copy function, a printer function, a document function and a FAX function, respectively, by carrying out user authentication after each shortcut key is pressed, a copy function screen 93a, a printer function screen 93b, a document function screen 93c and a FAX function screen 93d can be displayed. After the desired screen is displayed in this manner, the user makes setting needed for each image processing function to start image processing.

In this manner, in the conventional technology, at the time of authentication log-in, when operating a shortcut key by a dedicated hard key on an operation panel or by a soft key on a screen or the like, a desired operation screen is displayed without passing intervening operation screens.

However, even after the desired operation screen is displayed, some operations are necessary until an operation is decided and started. Accordingly, even in the case of a user who selects and uses the same function at all times or the case where it is only required to perform printing with default setting kept, it is troublesome to perform the same operation every time and the execution time until processing is started becomes longer.

In fact, as described also in Japanese Laid-Open Patent Publication No. 2002-354170, with the conventional operation of a shortcut key, intervening operation screens are skipped to reduce the number of operations so that a desired operation screen can be displayed directly, but a next operation is not executed from the screen. Of course, if it is necessary to make detailed setting of each image processing function, the operation has to be performed from the desired operation screen, but even in a case where it is desired to perform printing immediately with default setting kept and a case where a server has only one file, the operation is executed only after proceeding by selection of the file or by a printing execution button, which is burdensome and takes a long time.

### SUMMARY OF THE INVENTION

An object of the present invention is to enable, in an image processing apparatus having a plurality of image processing functions and capable of carrying out user authentication, to reduce the number of operations by a user and to display an initial operation screen of a desired image processing function and execute image processing by the image processing function.

The first technical means of the present invention is an image processing apparatus having a plurality of image processing functions, comprising an operation portion capable of displaying an operation screen, a user authenticating portion, and a registration portion for registering, with respect to an operation screen of the image processing function displayed through inputting of a user operation, the operation screen and a numeric key input before or after user authentication processing by the user authenticating portion being associated with each other for each user who is able to be authenticated by the user authenticating portion, wherein when the user authentication processing and inputting of the numeric key are performed, the operation screen, or a screen during execution or after execution of image processing by the image processing function is displayed as well as image processing by the image processing function is executed.

The second technical means of the present invention is the image processing apparatus of the first technical means, wherein when a number key is input subsequent to inputting of the numeric key, image processing by the image processing function associated with the numeric key is repeated a repetition number shown by the number key, and when the number key is not input subsequent to inputting of the numeric key, image processing by the image processing function is executed once.

### BRIEF DESCRIPTION OF THE DRAWINGS

FIG. 1 is a view showing an exemplary configuration of an image forming apparatus that can be used as an example of an image processing apparatus according to the present invention;

FIG. 2 is a block diagram showing an exemplary functional configuration of an image forming apparatus as an example of the image processing apparatus according to the present invention;

FIG. 3 is an external view showing an example of an operation panel in the image forming apparatus of FIG. 2;

FIG. 4 is a flowchart for explaining an example of entire processing including user authentication processing in the image forming apparatus of FIG. 2;

FIG. 5 is a flowchart for explaining an example of shortcut key registration processing in the processing of FIG. 4;

FIG. 6 is a view showing an example of a relation between a shortcut key registered at the shortcut key registration processing of FIG. 5 and an image processing function associated therewith;

FIG. 7 is a schematic view showing a specific example when the shortcut key registration processing of FIG. 5 is started;

FIG. 8 is a schematic view specifically showing shortcut key registration processing of a copy function, which is processing subsequent to FIG. 7;

FIG. 9 is a schematic view specifically showing shortcut key registration processing of a printer function, which is processing subsequent to FIG. 7;

FIG. 10 is a schematic view specifically showing shortcut key registration processing of a FAX function, which is processing subsequent to FIG. 7;

FIG. 11 is a schematic view specifically showing shortcut key registration processing of a document function, which is processing subsequent to FIG. 7;

FIG. 12 is a flowchart for explaining an exemplary operation when a shortcut key is operated in the image forming apparatus of FIG. 2;

FIG. 13 is a schematic view showing a specific example of the operation when the shortcut key is operated in FIG. 12;

FIG. 14 is a conceptual view for explaining processing for moving to an initial operation screen of a copy function in the image forming apparatus of FIG. 2;

FIG. 15 is a conceptual view for explaining processing for moving to an initial operation screen of a printer function in the image forming apparatus of FIG. 2;

FIG. 16 is a conceptual view for explaining processing for moving to an initial operation screen of a document function in the image forming apparatus of FIG. 2;

FIG. 17 is a conceptual view for explaining processing for moving to an initial operation screen of a FAX function in the image forming apparatus of FIG. 2; and

FIG. 18 is a conceptual view for explaining processing for moving to an initial operation screen of a desired image processing function in an image forming apparatus with an authentication function by a conventional technology.

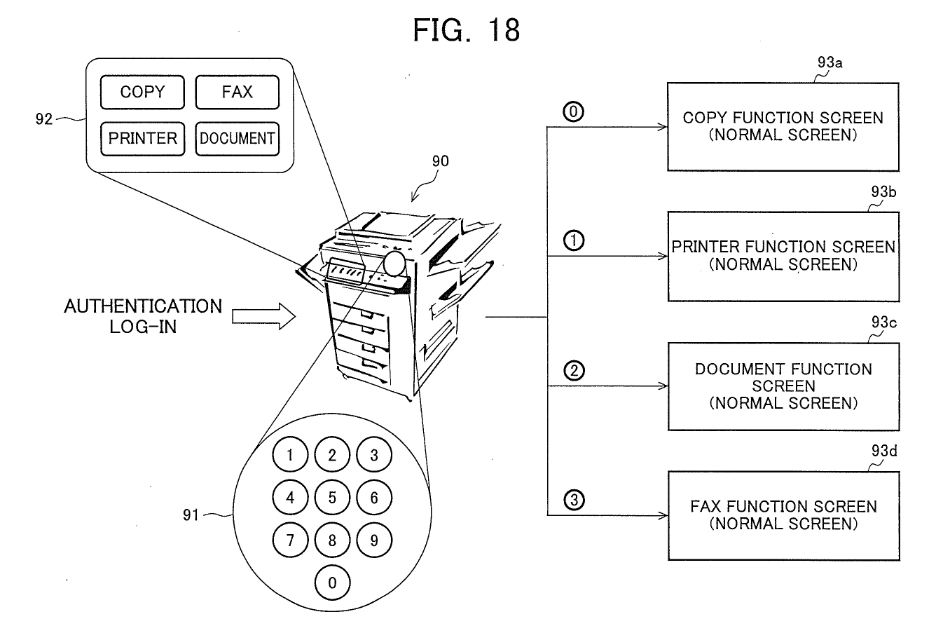

### PREFERRED EMBODIMENTS OF THE INVENTION

An image processing apparatus according to the present invention below is an apparatus having a plurality of image processing functions and description will hereinafter be given taking an image forming apparatus as an example. An example of the image forming apparatus includes a so-called digital multi-functional peripheral (MEP) which is only required to have at least two image processing functions. In addition, the image processing apparatus according to the present invention is not limited to the image forming apparatus and may be an image processing apparatus performing image processing with multiple kinds of methods. For example, a system provided with a general-purpose computer and a scanner and capable of performing image processing with two methods of color image reading processing and monochrome image reading processing and the like can be used as the image processing apparatus according to the present invention.

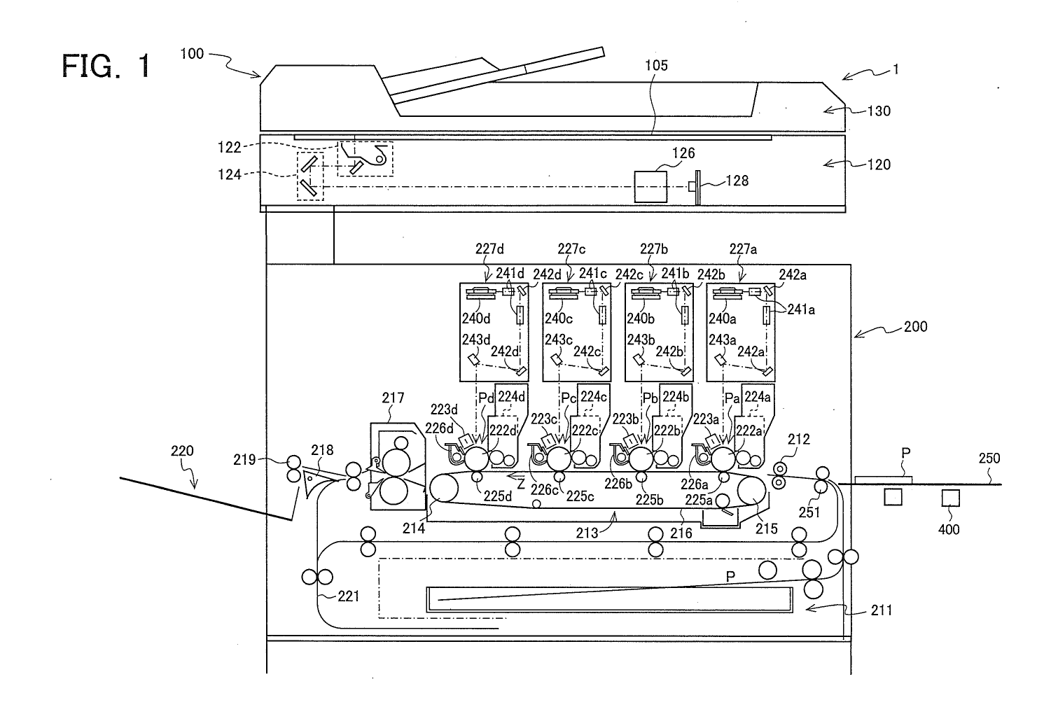

FIG. 1 is a view showing an exemplary configuration of an image forming apparatus that can be used as an example of the image processing apparatus according to the present invention, where 1 denotes an image forming apparatus. The image forming apparatus 1 illustrated in FIG. 1 is a digital color image forming apparatus and is mainly comprised of an image reading portion 100 and an image forming portion 200.

The image reading portion 100 is provided with a document table 105, an optical-system scanner portion 120 and a reversing automatic document feeder (RADF) 130. A document to be read is placed on the document table 105. The scanner portion 120 is disposed below the document table 105 to read an image in the document placed on the document table 105. The RADF 130 is disposed above the document table 105 and transports the document to be read to the document table 105 sequentially.

The scanner portion 120 is further comprised of a first scanning unit 122, a second scanning unit 124, an optical lens 126 and a CCD (Charge Coupled Device) line sensor 128. The first scanning unit 122 moves back and forth along a lower surface of the document table 105. At this time, the first scanning unit 122 moves at a predetermined scanning speed with a fixed distance maintained from the lower surface of the document table 105. The first scanning unit 122 is provided with an exposure lamp for exposing the surface of an image in a document and a first mirror for deflecting a reflection light image from the document in a predetermined direction.

The second scanning unit 124 is provided with a second mirror and a third mirror for guiding the reflection light image from the document, that has been deflected by the first mirror of the first scanning unit 122, in a direction of the CCD line sensor 128. The optical lens 126 reduces the reflection light image from the document, that has been deflected by the second lens and the third lens of the second scanning unit 124, and causes the reduced light image to be formed at a predetermined position on the CCD line sensor 128.

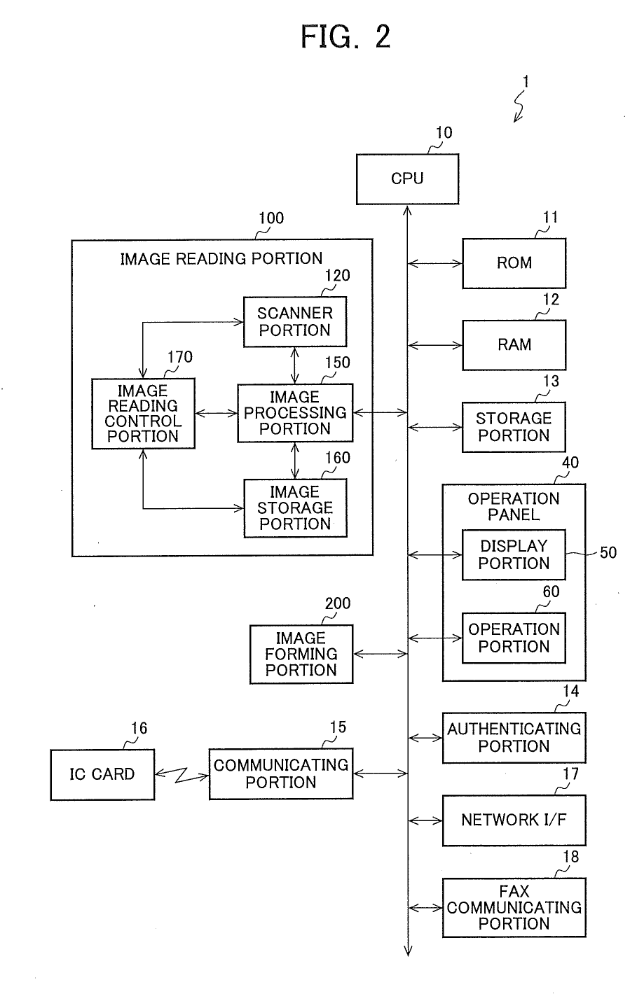

The CCD line sensor 128 performs optical conversion to the formed light image sequentially to output electric signals. The CCD line sensor 128 is a three-line color CCD which can read a monochrome image or a color image and output line data decomposed into each color component of R (red), G (green) and B (blue). The read image data converted into electric signals by the CCD line sensor 128 is further transferred to an image processing portion 150 (FIG. 2) described below and given image processing with predetermined procedure.

The image forming portion 200 is roughly comprised of a sheet feed portion, an image generating portion and a sheet discharge portion. The sheet feed portion is provided with a sheet feed cassette 211 and a manual tray 250. Note that, one sheet feed cassette 211 is illustrated in FIG. 1, but a plurality of sheet feed cassettes may be provided. A sheet transport path is formed between the sheet feed cassette 211 and the sheet discharge portion through the image generating portion. The sheet transport path is formed by an operation of a transport roller 251 and a sheet P is transported to a transfer sheet transport belt mechanism 213. Here, a pair of resist rollers 212 is disposed in a downstream side of the sheet feed cassette 211 and in an upstream side of the image forming portion in the sheet transport path. The resist rollers 212 adjust the timing to guide the sheet P to the image generating portion (transfer sheet transport belt mechanism 213).

In addition, there is also a case where the sheet P is fed from the manual tray 250. The sheet P placed on the manual tray 250 is transported to the transfer sheet transport belt mechanism 213 by the transport roller 251. Here, the manual tray 250 is provided with a sheet sensor 400 for detecting presence of a sheet. The sheet sensor 400 detects presence of a sheet placed on the manual tray 250 and a length of the sheet, and is used for detecting a regular sheet size. Note that, although description has been given for a case where the manual tray 250 is used as a method for feeding the sheet P as a manually fed sheet, of course, this is also applicable to a case where the sheet feed cassette 211 is used.

The image generating portion is provided with four image forming stations Pa, Pb, Pc and Pd, and is provided with the transfer sheet transport belt mechanism 213 that is arranged opposite to the image forming stations Pa, Pb, Pc and Pd across the sheet transport path.

Each image forming station Pa, Pb, Pc and Pd actually has the same configuration. The image forming stations Pa, Pb, Pc and Pd are provided with photoreceptor drums 222a to 222d as image carriers. In addition, at the periphery of the photoreceptor drums 222a to 222d, charging units 223a to 223d, laser beam scanning unit 227a to 227d, developing devices 224a to 224d, transfer discharging units 225a to 225d and cleaning devices 226a to 226d are disposed.

The charging units 223a to 223d uniformly charge peripheral surfaces of the photoreceptor drums 222a to 222d. The laser beam scanning units 227a to 227d are provided with polygon mirrors 240a to 240d, f_{″} lenses 241a to 241d, mirrors 242a to 242d and mirrors 243a to 243d. The laser beam scanning units 227a to 227d form electrostatic latent images on the peripheral surfaces of the photoreceptor drums 222a to 222d based on image data input from the image reading portion 100. The developing devices 224a to 224d supply developer to the electrostatic latent images formed on the peripheral surfaces of the photoreceptor drums 222a to 222d to form developer images. The transfer discharging units 225a to 225d transfer the developer images formed on the peripheral surfaces of the photoreceptor drums 222a to 222d to the sheet P in the sheet transport path. The cleaning devices 226a to 226d remove developer remaining on the photoreceptor drums 222a to 222d.

The transfer sheet transport belt mechanism 213 is provided with a driving roller 214, a driven roller 215 and a transfer sheet transport belt 216 which is tensioned by a plurality of rollers including these rollers. The transfer sheet transport belt mechanism 213 guides the sheet P to a downstream side of the sheet transport path with the sheet P electrostatically absorbed to the transfer sheet transport belt 216 which rotates in a counterclockwise direction in the figure.

In a downstream side of the transfer sheet transport belt mechanism 213 in the sheet transport path, a fixing device 217, a switching gate 218 and a sheet discharge roller 219 are disposed. The fixing device 217 is adhered to the sheet P to fix an unfixed developer image to the sheet P. The switching gate 218 switches a transport direction of the sheet P. Specifically, the switching gate 218 selectively switches the sheet P transported in the sheet transport path to either the sheet discharge roller 219 or a switchback transport path 221. The sheet discharge roller 219 discharges the sheet P outside the image forming apparatus 1. Note that, a sheet discharge tray 220 for storing the sheet P that is discharged from the sheet discharge roller 219 is disposed outside the image forming apparatus 1.

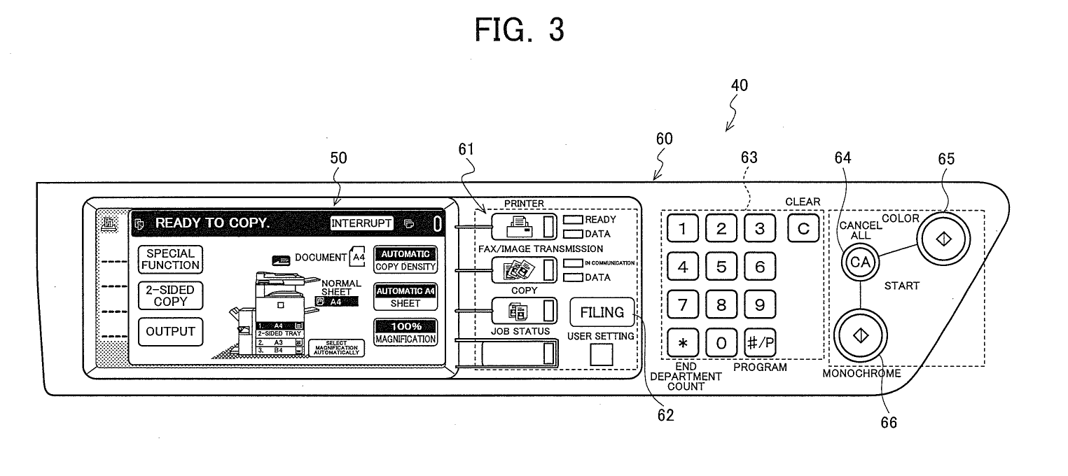

FIG. 2 is a block diagram showing an exemplary functional configuration of an image forming apparatus according to the present invention, which is also a block diagram showing an exemplary functional configuration of the image forming apparatus of FIG. 1. In addition, FIG. 3 is an external view showing an example of an operation panel in the image forming apparatus of FIG. 2. The image forming apparatus 1 illustrated in FIG. 2 is provided with an operation panel 40, in addition to the image reading portion 100 and the image forming portion 200 illustrated in FIG. 1, and is further provided with a CPU 10, a ROM 11, a RAM 12, a storage portion 13, an authenticating portion 14, a communicating portion 15 and a network I/F 17. An IC card 16 is prepared by an administrator for user authentication and is held by a user.

The CPU 10 is an example of a control portion for executing each function by reading out various programs and data stored in the ROM 11 for execution. Note that, the CPU 10 is able to realize various functions by programs and a function of the image processing portion 150 describe below may be realized by the CPU 10, for example. The ROM 11 stores programs and data needed for the operation of the image forming apparatus 1 in this manner. Moreover, the RAM 12 is a volatile memory for firstly accumulating image data and the like and, for example, an image read by the image reading portion 100 is output and stored in the RAM 12. In addition, the storage portion 13 is comprised of an HDD (hard disc drive) and other nonvolatile memory and stores authentication data and registration data, which will be described below, according to the present invention.

The image reading portion 100 has the image processing portion 150 connected to the scanner potion 120, an image storage portion 160 and an image reading control portion 170. Image data read by the scanner portion 120 is processed at the image processing portion 150 and temporarily stored in the image storage portion 160. When reading of a document is completed, then the data is output to the RAM 12. The image storage portion 160 is comprised of an HDD and the like and image data is filed in the image storage portion 160. In addition, the scanner portion 120, the image processing portion 150 and the image storage portion 160 function being controlled by the image reading control portion 170. Moreover, the image forming portion 200 forms an image of the read image data for output. The read image data is printed to the sheet P by the image forming portion 200 and output from the image forming apparatus 1.

The operation panel 40 is comprises of a display portion 50 and an operation portion 60 and is used when a user operates the image forming apparatus 1. The display portion 50 is able to carry out necessary display for a user and is comprised of, for example, an LCD (liquid crystal display) and the like. Note that, an initial operation screen of a copy function is illustrated in FIG. 3 as a display screen in the display portion 50. In addition, the operation portion 60 receives inputting of commands, setting and the like from a user and is comprised of, for example, various operation buttons, a touch panel provided in the display portion 50 and the like. In addition to the touch panel, the operation portion 60 has a function selection button 61 for selecting a printer function, a fax/image transmission function, a copy function and the like, a filing button 62 for accessing image data, a numeric keypad group 63 comprised of numeric buttons, a batch cancel button 64, a color copy start button 65 and a monochrome copy start button 66, as illustrated in FIG. 3.

The communicating portion 15 is constituted as a so-called card reader and carries out user authentication by communicating with the authenticating portion 14. The IC card 16 includes an antenna, an IC chip and a power supply portion. When the IC card 16 is closed, the card reader performs radio communication with an antenna on the IC card 16 side with the mounted antenna, and reads and analyzes authentication information such as an ID and a password in the IC chip to provide to the authenticating portion 14. The authenticating portion 14 matches authentication data that is registered in advance with authentication information obtained from the communicating portion 15 to perform user authentication processing. The authentication is success if the matching is success, and a signal to the effect that use of the image forming apparatus 1 is to be allowed and information specifying a user of the matched ID or the like, for example, are transmitted to the CPU 10. The authentication is failed if the matching is not success, and information to the effect of failure is transmitted to the CPU 10. The authentication result is displayed on the display portion 50 of the operation panel 40 based on an instruction from the CPU 10.

In addition, as the authentication data described above, for example, a user name, an ID code (corresponding to a user ID), a password, a name of a group to which a user belongs (corresponding to a group ID), an E-mail address, a portable phone number and the like may be registered preferably in a table format. Of course, only a user name or an ID and a password may be simply stored as the authentication data. The registration destination is the storage portion 13 in this example. Moreover, the authenticating portion 14 is not only to perform user authentication processing by the IC card 16 but may simply receive inputting of a user ID (and a password) from the operation portion 60 to match with authentication data in the storage portion 13 based on information input from the operation portion 60. In particular, the authentication data is preferably stored being correlated to registration data in the storage portion 13. The registration data indicates data, for example, registering processing contents of shortcut keys for each user, which will be described below.

The network I/F 17 is a communication interface for connecting with an information processing apparatus such as a PC (personal computer) used by a user or a server through a communication line such as a LAN (Local Area Network). In addition, the FAX communicating portion 18 is an interface for performing facsimile communication with other facsimile apparatus through a facsimile line.

The image forming apparatus 1 according to the present invention is provided with a user authenticating portion for performing user authentication processing as illustrated in the communicating portion 15, the authenticating portion 14, and authentication data in the storage portion 13, and is provided with an operation portion (an operation device corresponding not only to the operation portion 60 but to the operation panel 40) capable of displaying an operation screen as illustrated in the operation panel 40 (the display portion 50 and the operation portion 60).

Further, the image forming apparatus 1 according to the present invention is, as a main characteristic, provided with the following registration portion. With respect to an operation screen of an image processing function (for example, an initial operation screen of the image processing function) that is displayed through inputting of a user operation in a state where an operation screen is displayed, the registration portion registers the operation screen and a numeric key input before (or after) user authentication processing by the user authenticating portion being associated with each other for each user who is able to be authenticated by the user authenticating portion. The registration portion can be illustrated by the operation panel 40 performing inputting of information about the registration, the storage portion 13 which is an example of the registration destination, and the CPU 10 for controlling them.

In addition, data registered in the storage portion 13 (registration data) is data associating an operation screen and a numeric key as described above, but the operation screen does not need to be image data itself of a screen and is only required to be data capable of reading out image data of an associated screen, such as data showing the saving destination of the image data. Moreover, the registration is carried out after user authentication processing as described below, the registration data is also stored for each user. In addition, the numeric key is comprised of any one or a plurality of keys of hardware keys and/or software keys provided as the operation portion 60 (also including the touch panel), but is preferably one key so as to be able to be operated by a single operation. Moreover, it is also necessary to store, as the registration data, whether the numeric key is input before user authentication processing or after user authentication processing.

When the numeric key is input before user authentication processing and user authentication processing is given, the CPU 10 in the image forming apparatus 1 displays an operation screen or a screen during execution or after execution of image processing by an image processing function as well as executes image processing by an image processing function corresponding to the operation screen. Alternatively, when the numeric key is input after user authentication processing, the CPU 10 displays an operation screen as well as executes image processing by an image processing function corresponding to the operation screen. The image processing executed at this time indicates, for example, processing executed when an execute key or a start key is pressed in a normal state in the operation screen, and, for example, an initial operation screen of a copy function is displayed as well as copy processing is executed.

In this manner, in the present invention, when an operation screen is displayed, with user authentication processing and an operation of the numeric key (hardware key and software key) on the operation panel, intervening operation screens are skipped and an operation screen desired by a user, that is associated with the numeric key, is displayed as well as the next operation in the desired operation screen is executed. Taking an example in a print function (or a data deletion function in the print function), when it is desired to print data placed on a server immediately using the printer function, just by carrying out logging-in using a shortcut key by the associated numeric key, printing (or deletion) is executed, so that it is possible to reduce the number of operations and the time required until execution. That is, according to the present invention, in the image processing apparatus having a plurality of image processing functions and capable of carrying out user authentication, the number of operations by a user is reduced by eliminating operations unnecessary for the user, so that it is possible to display an operation screen of a desired image processing function and execute image processing by the image processing function, and this makes it possible to improve user convenience.

Description will hereinafter be given for processing for registering a shortcut key by the specific numeric key and processing for displaying an operation screen after the registration and executing the associated operation.

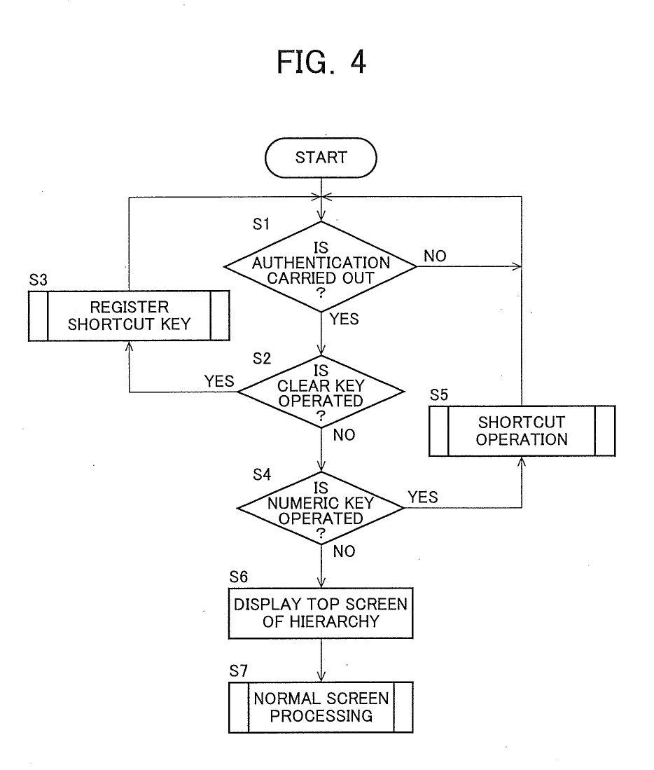

First, an example of entire processing including user authentication processing in the image forming apparatus of FIG. 2 will be described with reference to the flowchart of FIG. 4.

The CPU 10 of the image forming apparatus 1 carries out logging-in by an authentication system while pressing a clear key (C) of the numeric keypad group 63, for example, in the operation portion 60 so as to move to a registration screen of shortcut keys. Based on such a rule, the CPU 10 firstly determines whether or not user authentication processing is performed by the authenticating portion 14 (step S1), and when user authentication processing is not performed, the flow goes back to step S1 to wait for user authentication processing. On the other hand, when user authentication processing is performed (in the case of YES at step S1), the CPU 10 determines whether or not the user authentication processing is performed in a state where the clear key is pressed (step S2). In the case of YES at step S2, based on the rule described above, the flow moves to shortcut key registration processing (step S3). After the shortcut key registration processing, the flow goes back to step S1 immediately or after a predetermined time has elapsed.

On the other hand, in the case of NO at step S2, the CPU 10 determines whether or not the numeric key is operated in the operation portion 60 (step S4), and when the numeric key is operated, an operation associated with a registered shortcut (shortcut key associating processing) is performed (step S5). After the processing of the shortcut key operation, the flow goes back to step S1 immediately or after a predetermined time has elapsed. In the case of NO at step S4, the CPU 10 causes the display portion 50 to display a top screen of the hierarchy (for example, such as a menu screen serving as a selection screen of an image processing function) in a user interface screen displayed by the display portion 50 (step S6). Then, the flow moves to normal screen processing (step S7). Note that, even when processing to wait until a predetermined time has elapsed after the processing at step S3 or step S5 is employed, it is only required to wait in a state of moving to normal screen processing like step S7.

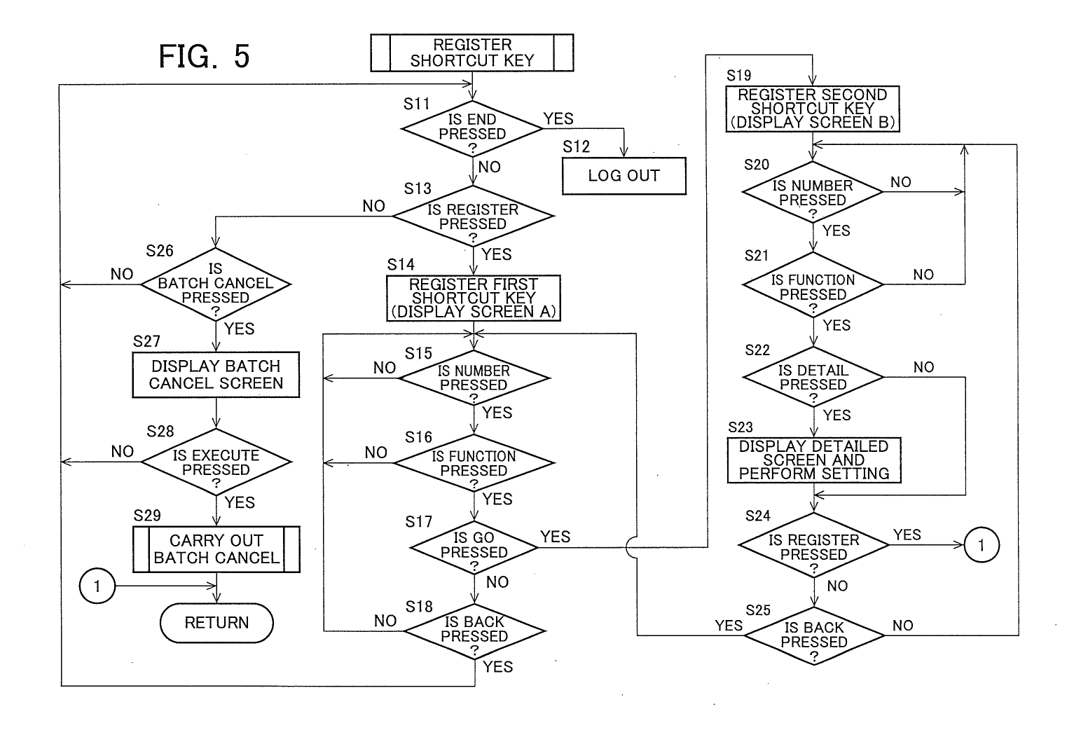

Next, the shortcut key registration processing (step S3) in the processing of FIG. 4 will be described with reference to FIGS. 5 to 11. The shortcut key registration processing is executed by the registration portion described above, more specifically, while receiving inputting by the operation portion 60 and carrying out display by the display portion 50 under control from the CPU 10, for example. A main part of individual processing will be often omitted below to simplify the description.

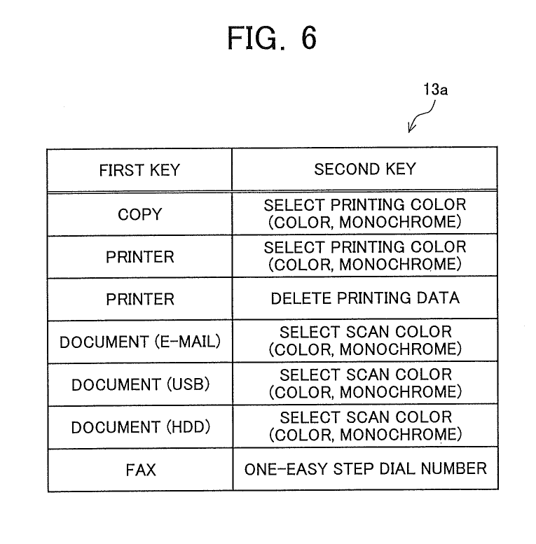

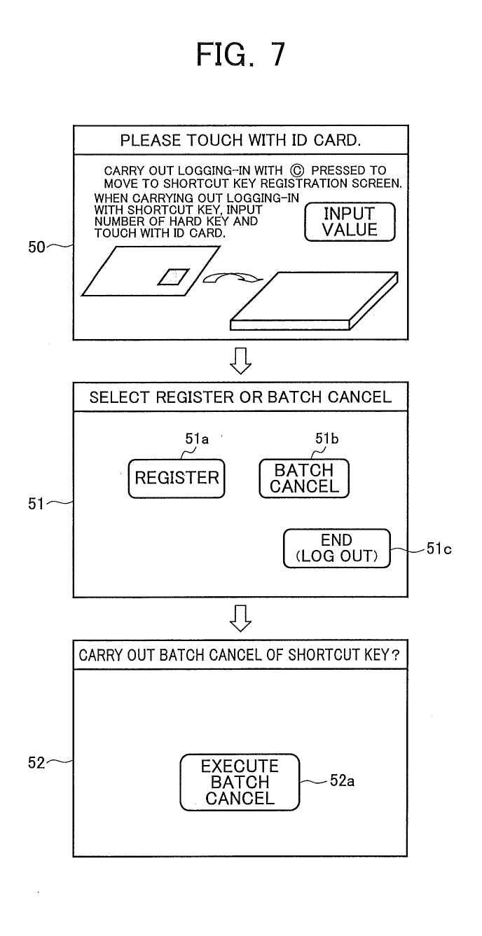

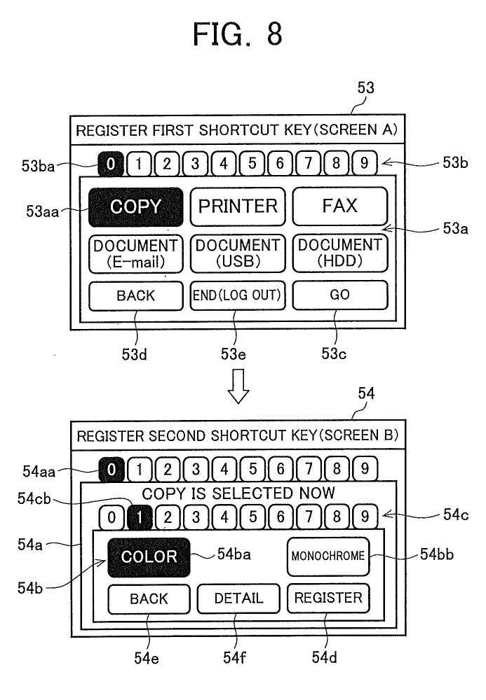

FIG. 5 is a flowchart for explaining an example of shortcut key registration processing in the processing of FIG. 4 and FIG. 6 is a view showing an example of a relation between a shortcut key registered at the shortcut key registration processing of FIG. 5 and an image processing function associated therewith. In addition, FIG. 7 is a schematic view showing a specific example when the shortcut key registration processing of FIG. 5 is started. Moreover, FIGS. 8 to 11 are schematic views specifically showing shortcut key registration processing of image processing functions, all of which is processing subsequent to FIG. 7. FIGS. 8, 9, 10 and 11 are schematic views specifically showing shortcut key registration processing of a copy function, a printer function, a FAX function and a document function, respectively, as image processing functions.

The shortcut key registration processing is started firstly when user authentication processing is performed by an ID card (for example, an IC card or a magnetic card) while pressing the clear key describe above. Taking a specific example of a screen, display is carried out to prompt authentication by showing “please touch with an ID card” or the like as shown in a screen 50 of FIG. 7 as well as display is also carried out to explain how to register by showing “carry out logging-in with (C) pressed to move to a shortcut key registration screen” or the like. Note that, in the screen 50, an input field for input value is also prepared and this input field is used when the shortcut key operation is carried out after registration, description of which will be given below.

With the clear key pressed in a state where the screen 50 is displayed and with user authentication processing, the screen moves to a screen 51. The screen 51 displays a register key 51a, a batch cancel key 51b and an end key 51c so as to be selectable. First, it is determined whether or not the end key 51c is pressed (step S11), and when the end key 51c is pressed, logging-out is carried out (step S12). When the end key 51c is not pressed, it is determined whether or not the register key 51a is pressed (step S13). In the case of NO at step S13, it is determined whether or not the batch cancel key 51b is pressed (step S26), and when the batch cancel key 51b is pressed, a batch cancel screen of a screen 52 is displayed (Step S27). The screen 52 displays an execute batch cancel key 52a so as to be selectable for confirmation to a user. Here, it is determined whether or not the execute batch cancel key 52a is pressed (step S28), and when the execute batch cancel key 52a is pressed, the registered shortcut key of the user is collectively cancelled (step S29) to complete the shortcut registration processing. It is only required to delete the registration data about the user at step S29. Thereby, the shortcut key of the user that has been registered is all cancelled so that logging-in with the shortcut key can not be executed. Alternatively, in the case of NO at step S26 or in the case of NO at step S28, the flow goes back to step S11.

On the other hand, the case of YES (the case where the register key is pressed) at step S13 results in the shortcut key registration processing. At the shortcut key registration processing, for example, as illustrated in a registration function list 13a of FIG. 6, first and second shortcut keys are registered. The type of an image processing function and setting contents thereof are registered in the first and second keys, respectively. Note that, as to the operation when the shortcut key is pressed, which will be described below, for example, in the case of the copy function and the printer function, by allocating “the number of copies” automatically as a third key, it is only required to print the number of copies, that is actually input by the third key, when the shortcut key is pressed after registration. Of course, the actual number of copies may be allocated, but the desired number of copies changes moment to moment so that it is preferable to simply allocate only “showing the number of copies”.

Accordingly, in the case of YES at step S13, a first shortcut key registration screen (called screen A) is firstly displayed and the first shortcut key registration processing is started (step S14). Examples of the screen A include screens A 53 as illustrated in FIGS. 8 to 11. The screens A 53 display a number tab (number key) 53b and a key group 53a of main functions of a multi-functional peripheral (copy, printer, document (E-mail transmission, USB saving and HDD saving) and FAX) so as to be selectable, where the function to be associated with the first key is firstly set. In addition to these keys, the screens A 53 of FIGS. 8 to 11 display a back key 53d, an end key 53e and a go key 53c so as to be selectable.

Subsequent to step S14, it is determined whether or not the number key 53b is pressed (step S15), and the flow goes to the next step only after the number key 53b is pressed to determine whether or not the function key group 53a is pressed (step S16). In the case of NO at step S16, the flow goes back to step S15, and when the function key group 53a is pressed, it is determined whether or not the go key 53c is pressed (step S17). For example, steps S15 and S16 may not be performed in this order. In the case of NO at step S17, it is determined whether or not the back key 53d is pressed (step S18). In the case of NO at step S18, the flow goes back to step S15. In the case of YES at step S18, the flow goes back to step S11 to wait for pressing of the end key (the end key 53e in this case) and logging-out is carried out when the end key is pressed (step S12).

In addition, in the case of YES at step S17, a second shortcut key registration screen (called screen B) is displayed and second shortcut key registration processing is started (step S19). Examples of the screen B include screens 54 as illustrated in FIGS. 8 to 11. The screens B 54 display a tab showing a number that has been selected by the number key 53b (for example, a tab where number 54aa and the like are lined up in FIG. 8) and a box 54a. The box 54a displays a key group 54b of further functions (for example, setting item) associated with the function that has been selected (any of copy, printer, document (E-mail transmission, USB saving and HDD saving) and FAX) and a number tab 54c for associating therewith so as to be selectable, where the function to be associated with the second key is set. In addition to these keys, the screens B 54 of FIGS. 8 to 11 display a back key 54e, a detail key 54f and a register key 54d so as to be selectable.

Subsequent to step S19, it is determined whether or not the number key 54c is pressed (step S20), and the flow goes to the next step only after the number key 54c is pressed to determine whether or not the function key group 54b is pressed (step S21). In the case of NO at step S21, the flow goes back to step S20, and when the function key group 54b is pressed, it is determined whether or not the detail key 54f is pressed (step S22). For example, steps S20 and S21 may not be performed in this order. In the case of NO at step S22, it is determined whether or not the register key 54d is pressed (step S24), and when the register key 54d is pressed, by writing as a part of registration data, the processing is completed. In the case of NO at step S24, it is determined whether or not the back key 54e is pressed (step S25), and in the case of YES, the flow goes back to step S15, while in the case of NO, the flow goes back to step S20. Alternatively, in the case of YES at step S22, a detailed screen is displayed to perform setting (step S23), followed by going to step S24. The detailed screen at step S23 is a screen that is displayed when further detailed setting is necessary, where user makes detailed setting, followed by going back to the screen B 54.

Based on the processing procedure as describe above, a user performs the shortcut key registration processing. FIG. 8 illustrates a case where registration processing of the copy function is performed. The screen A 53 of FIG. 8 shows a state where a key 53ba showing “0” and a key 53aa showing copy are selected and associated with each other. After deciding the first association in this manner, the user presses the go key 53c to display the screen B 54. In the screen B 54, the user carries out second key association. This example shows a state where a key 54cb showing “1” is selected from the number key 54c, and as a function to be associated therewith (setting item, select color in this example), a color key 54ba is selected from the function key group 54b having the color key 54ba and a monochrome key 54bb. Note that, the screen B 54 also displays a key 54aa associated with the key 53ba. At this time, a detailed function such as sheet selection or a magnification may be associated using the detail key 54f depending on the function. When pressing the register button 54d at last, the screen returns to the screen A 53 so that registration for the shortcut key is completed. In addition, in the screen A 53, the screen B 54 and a screen C described below, the selection of the number tab being selected among the number key 53b and the key being selected among the function group key 53a, for example, is canceled when being pressed again, and selection of the selected part is also cancelled when other key (such as a tab showing “8” in the example of the number key 53b of FIG. 8, for example) is selected, which will not be described specifically below.

In the example of FIG. 8, “01” is registered as a shortcut key for the copy function and for executing color copy. Note that, when the register key 54d is pressed in a state where nothing is selected in the screen B 54, color selection is determined automatically, and output may be carried out, for example, with color setting on a PC as it is. On the other hand, in the case of monochrome copy, monochrome output is carried out forcibly even in the case of color on the PC. As described above, when pressing the register button 54d at last, the screen returns to the screen A 53 so that registration for the shortcut key is completed, but registration of other shortcut key can be continuously performed in the same way. However, the same number (the first number 0 in this example) can not be associated with other function (except for the copy function) in a duplicated manner. Then, after registering each function being associated with each other in this manner, the screen returns to the screen A 53 at last, where the end key 53e is pressed to carry out logging-out.

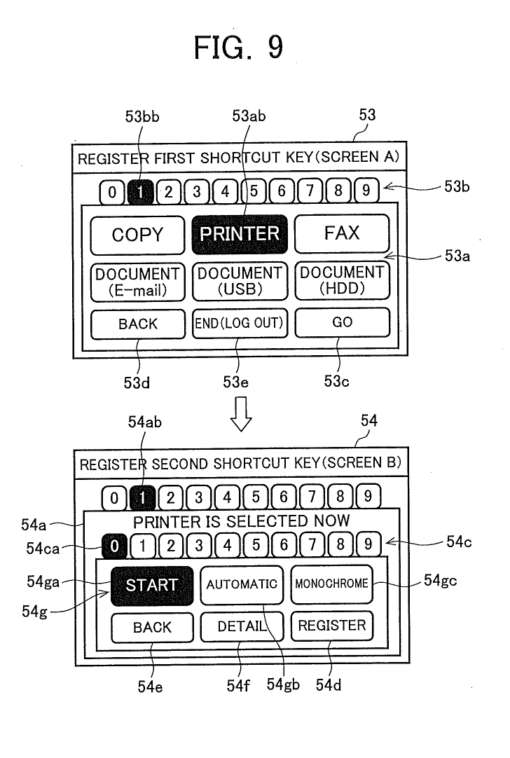

FIG. 9 illustrates a case where registration processing of the printer function is performed. The screen A 53 of FIG. 9 shows a state where a key 53bb showing “1” and a key 53ab showing printer are selected and associated with each other. After deciding the first association in this manner, the user presses the go key 53c to display the screen B 54. In the screen B 54, the user carries out second key association. This example shows a state where a key 54ca showing “0” is selected from the number key 54c, and as a function to be associated therewith (setting item, processing to be performed in this example), a start key 54ga is selected from a function key group 54g having the start key 54ga, an automatic key 54gb and a monochrome key 54gb. Note that, the screen B 54 also displays a key 54ab associated with the key 53bb. At this time, a detailed function such as sheet selection or a magnification may be associated using the detail key 54f depending on the function. When pressing the register button 54d at last, the screen returns to the screen A 53 so that registration for the shortcut key is completed.

In the example of FIG. 9, “10” is registered as a shortcut key for the print function and for executing start (start the operation directly). Note that, when the automatic key 54gb is selected, monochrome/color is selected automatically to execute the operation, and when the monochrome key 54gc is selected, monochrome printing is carried out forcibly. The case where the register key 54d is pressed in a state where nothing is selected in the screen B 54 may be considered as that, for example, the start key 54ga is selected. As described above, when pressing the register button 54d at last, the screen returns to the screen A 53 so that registration for the shortcut key is completed, but registration of other shortcut key can be continuously performed in the same way. However, the same number (the first number 1 in this example) can not be associated with other function (except for the printer function) in a duplicated manner. Then, after registering each function being associated with each other in this manner, the screen returns to the screen A 53 at last, where the end key 53e is pressed to carry out logging-out.

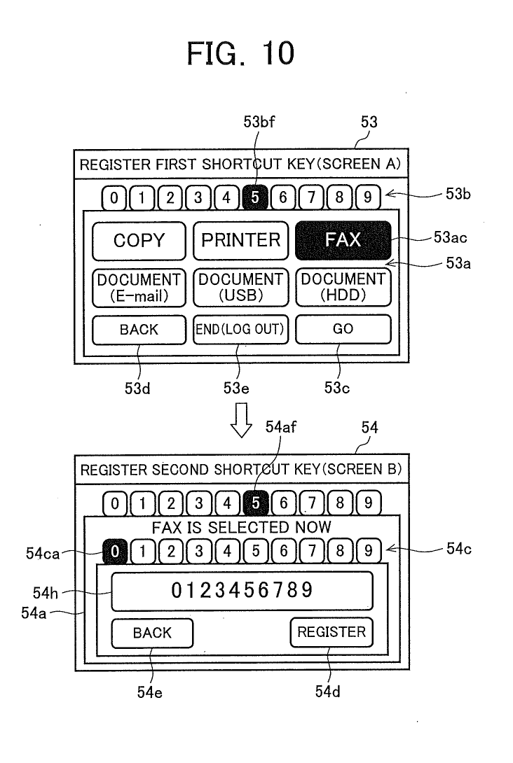

FIG. 10 illustrates a case where registration processing of the FAX function is performed. The screen A 53 of FIG. 10 shows a state where a key 53bf showing “5” and a key 53ac showing FAX are selected and associated with each other. After deciding the first association in this manner, the user presses the go key 53c to display the screen B 54. In the screen B 54, the user carries out second key association. This example shows a state where the key 54ca showing “0” is selected from the number key 54c, and “0123456789” is input in an input field 54h of a function to be associated therewith (setting item, FAX number in this example). Note that, the screen B 54 also displays a key 54af associated with the key 53bf. Note that, an example is given in which a detail key is not provided for the FAX function because it is considered detailed setting is not made for the FAX function. When pressing the register button 54d at last, the screen returns to the screen A 53 so that registration for the shortcut key is completed.

In the example of FIG. 10, “50” is registered as a shortcut key for the FAX function and for executing communication to the FAX number “0123456789”. That is, one-easy step dialing to the FAX number can be set, and there are ten numbers in the example of the number key 54c so that it is possible to register FAX processing with ten pieces of one-easy step dialing. A case where the register key 54d is pressed in a state where nothing is selected in the screen B 54 may be considered such as, for example, waiting in a state where the FAX number is input and in an on-hook state. As described above, when pressing the register button 54d at last, the screen returns to the screen A 53 so that registration for the shortcut key is completed, but registration of other shortcut key can be continuously performed in the same way. However, the same number (the first number 5 in this example) can not be associated with other function (except for the FAX function) in a duplicated manner. Then, after registering each function being associated with each other in this manner, the screen returns to the screen A 53 at last, where the end key 53e is pressed to carry out logging-out.

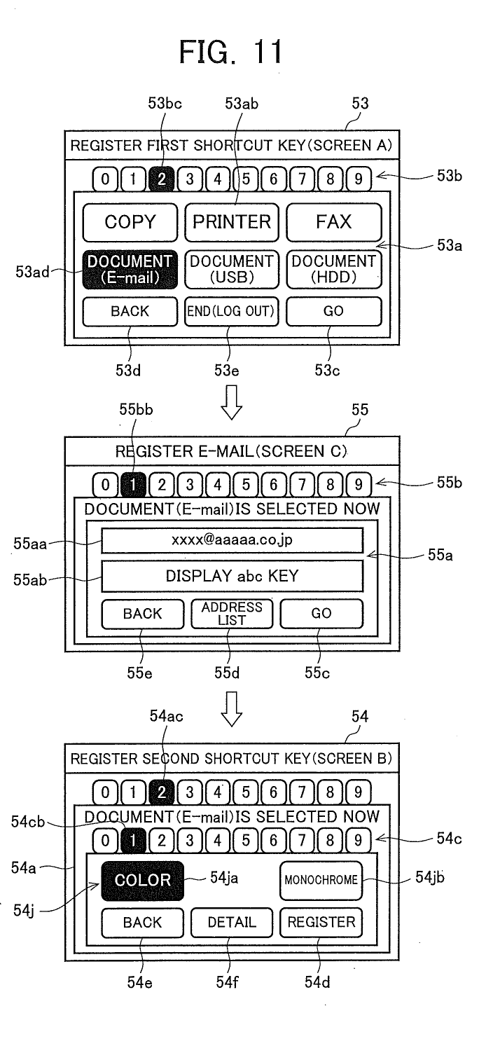

FIG. 11 illustrates a case where registration processing of the document function (transmission of an electronic file of a document) is performed. The screen A 53 of FIG. 11 shows a state where a key 53bc showing “2” and a key 53ad showing a document (E-mail) are selected and associated with each other. After deciding the first association in this manner, the user presses the go key 53c to display a screen C 55. In the screen C 55, the user registers an E-mail transmission destination. Therefore, the screen C 55 is provided with an E-mail address input box 55a as well as a number key 55b. This example shows a state where a key 55bb showing “1” is selected from the number key 55b, and “xxxx@aaaaa.co.jp” is input in an input field 54aa. Note that, a display-abc-key key 55ab is a key for displaying a keyboard to input an address in an input field 55aa. In addition, the screen C 55 displays a back key 55e for returning to the screen A 53, an address list key 55d for displaying an address list which also serves as alternative input means for the display-abc-key key 55ab as well as a go key 55c for going to the next screen B so as to be selectable. The address list key 55d is selected so that the user is able to select an address which should be input in the input field 54aa from the address list. The user presses the go key 55c to display the screen B 54.

In the screen B 54, the user carries out second key association. This example shows a state where the key 54cb showing “1” is selected from the number key 54c, and as a function to be associated therewith (setting item, select color in this example), a color key 54j a is selected from a function key group 54j having the color key 54ja and a monochrome key 54jb. Note that, the screen B 54 also displays a key 54ac associated with the key 53bc. At this time, a detailed function such as a resolution, a file format, execution of coding, addition of important mark may be associated using the detail key 54f depending on the function. Note that, it may be configured such that detailed setting is not made for the document (E-mail) function. When pressing the register button 54d at last, the screen returns to the screen A 53 so that registration for the shortcut key is completed.

In the example of FIG. 11, “21” is registered as a shortcut key for, with respect to a scanned document file, the E-mail transmission function and transmitting the E-mail to the address “xxxx@aaaaa.co.jp”. That is, one-easy step transmission to the E-mail address can be set. Such an E-mail transmission function after scanning using a shortcut key is assumed to be used at the time of transmitting to an E-mail address of an operator himself/herself so that it is only required to register one E-mail transmission destination basically. However, a case where a plurality of E-mail addresses of the operator himself/herself are used is also considered, thus it may be configured such that ten numbers are provided like an example of the number key 55b, and E-mail transmission processing by ten pieces of one-easy step transmission are registered. At this time, since there are a plurality of destinations, a shortcut key “211” is registered in the case of the example of FIG. 11. A case where the go key 55c is pressed in a state where nothing is selected in the screen C 55 may be considered such as, for example, waiting in a state where the E-mail address is input and in a state where mailer software is opened.

As described above, when pressing the register button 54d at last, the screen returns to the screen A 53 so that registration for the shortcut key is completed, but registration of other shortcut key can be continuously performed in the same way. However, the same number (the first number 2 in this example) can not be associated with other function (except for the document E-mail transmission function) in a duplicated manner. Then, after registering each function being associated with each other in this manner, the screen returns to the screen A 53 at last, where the end key 53e is pressed to carry out logging-out.

Moreover, in a case where a document (USB saving) is associated with a tab showing “3” among the number key 53b and the go key 53c is pressed, a second number tab and select color (color/monochrome) are then displayed (screen B) so that setting may be made as to which thereof is associated with the second number tab. The USB saving indicates filing a file subjected to image reading in an inserted USB memory, in a predetermined format. Further, in a case where a document (HDD saving) is associated with a tab showing “4” among the number key 53b and the go key 53c is pressed, a second number tab and select color (color/monochrome) are then displayed (screen B) so that setting may be made as to which thereof is associated with the second number tab. The HDD saving indicates filing a file subjected to image reading in a predetermined folder of an HDD, in a predetermined format.

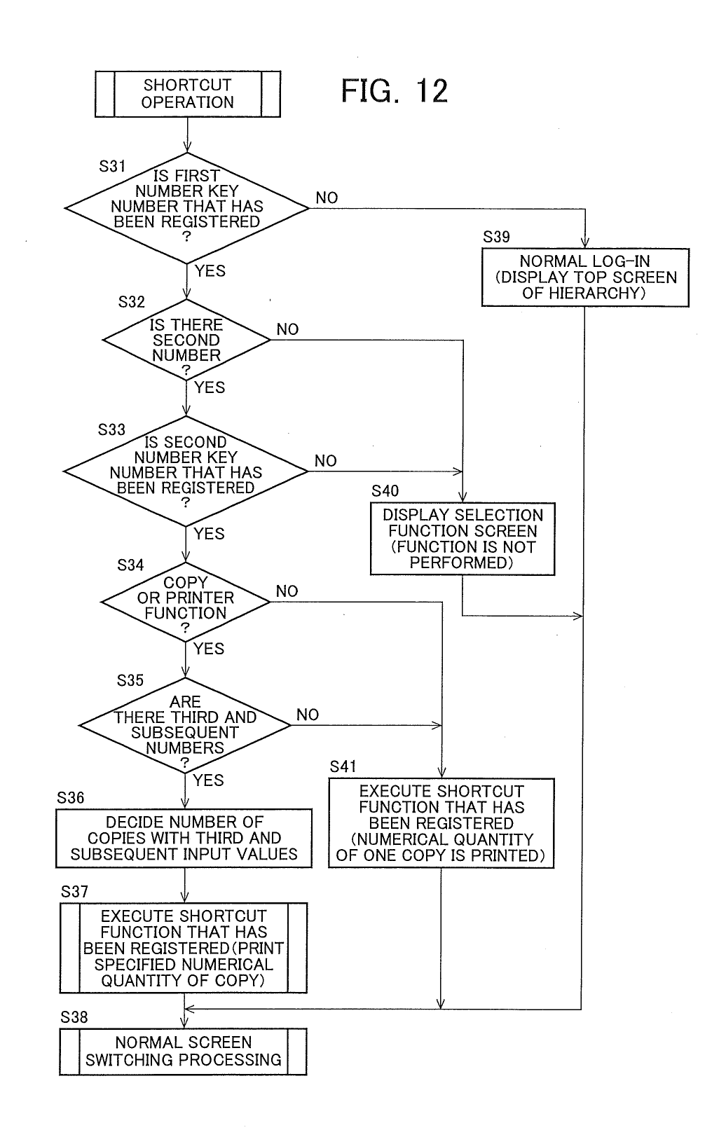

Next, an operation (shortcut key associating processing) (step S5) in the processing of FIG. 4 will be described with reference to FIGS. 12 to 17. As described above, the shortcut key associating processing is executed while receiving inputting by the operation portion 60 and carrying out display by the display portion 50 under control mainly from the CPU 10, and controlling the image reading portion 100, the image forming portion 200, the network I/F 17, the FAX communicating portion 18, and the like. A main part of individual processing will be often omitted below to simplify the description.

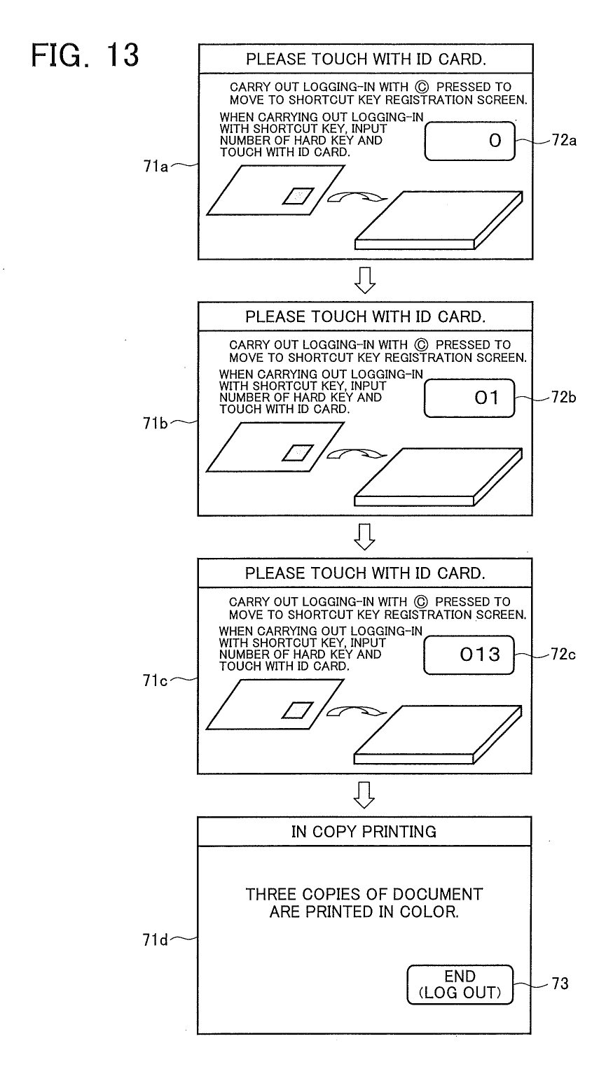

FIG. 12 is a flowchart for explaining an exemplary operation when a shortcut key is operated in the image forming apparatus of FIG. 2, and FIG. 13 is a schematic view showing a specific example of the operation when the shortcut key is operated in FIG. 12.

The shortcut key associating processing is started firstly when user authentication processing is performed by an ID card (for example, an IC card or a magnetic card) after inputting a shortcut key. Taking a specific example of a screen, display is carried out to prompt authentication by showing “please touch with an ID card” or the like as shown in a screen 71a of FIG. 13 (same screen as the screen 50 of FIG. 7) as well as an input field 72a is displayed so as to be capable of being input. An input value is input with the numeric key. Note that, holding of the input value with the numeric key may be disabled and the value may be deleted after exceeding a certain period of time to prevent an unnecessary input value from being left and disturbing logging-in before using.

The screen 71a shows a state where “0” is input in an input field on the initial screen as shown by the input field 72a. Next, when inputting is performed (“1” is input in this example) in the input field 72a in a state where the screen 71a is displayed, the screen moves to a screen 71b and the field is as shown by an input field 72b, and when inputting is further performed (“3” is input in this example) in the input field 72b, the screen moves to a screen 71c and the field goes into a state where “013” is input as a shortcut key as shown by an input field 72c. The user confirms the state to perform user authentication processing by touching with an IC card and the like. Thereby, screen display (display of a screen 71d) and processing (color copy and number of copies of “three” in this example) associated with the shortcut key are executed. The example is an inputting example where three copies of color copy are executed in which copying of a document which is set in advance is executed by printing three copies in color together with output of a message. Note that, although the screen 71d is shown as an operation screen of the copy function here, it may be configured such that a screen showing that the processing is in execution or the operation screen of the copy function is displayed before the screen showing that image processing has been executed is displayed in this manner. The end key 73 is then pressed in the state to carry out logging-out. In a case where the apparatus is used continuously while keeping logging-in, for example, when a reset key is pressed, the screen returns to the menu screen (a default screen of function selection).

To explain a flow of the processing, first, when a function except for the printer function is executed, a document is set in advance. To give the following explanation schematically, a value input with the numeric key before logging-in is displayed on the operation panel, executing contents of shortcut is decided depending on the numbers input firstly and secondly so that third and subsequent numbers are set as the number of copies for copying and in a printer.

First, it is determined whether or not a first number input in an input field is the number of a key that has been registered (number registered as being associated with a function, and for example, “0” is a copy function in the example of FIG. 8) (step S31). In the case of NO at step S31, it is determined as a normal log-in, the normal logging-in is carried out to display a top screen of the hierarchy (menu screen) (step S39), and normal screen switching processing is performed in accordance with a user operation (step S38).

In the case of YES at step S31, it is determined whether or not there is input of a second number (step S32), and in a case where there is no input, display of a selection function screen (display of an operation screen of copying in the case where only “0” is input, for example) is carried out (step S40). The function is not executed at step S40 and the flow goes to step S38. In the case of YES at step S32, it is determined whether or not the second number which is input in the input field is the number of a key that has been registered (number registered as being associated with a setting item, for example, in a function, and “1” is color in the example of FIG. 8, for example) (step S33). In the case of NO at step S33, the flow goes to step S40. On the other hand, in the case of YES at step S33, it is determined whether the function is either the copy function, the printer function, or a function except therefor (step S34).

In the case of NO at step S34, a shortcut function that has been registered is executed (step S41). In the case of YES at step S34, it is determined whether or not there is inputting of third and subsequent numbers (step S35), and in the case of NO, a shortcut function that has been registered is executed (step S41). In the case of printing at step S41, execution is basically limited to minimum such that the number of copies is one only or the like. In the case of YES at step S35, the number of copies is decided according to third and subsequent numbers input in the input field (step S36), and a shortcut function that has been registered is executed with the number of copies (step S37). The flow goes to step S38 after step S37 or after step S41.

Note that, it is assumed in the example of the processing that an input value is determined after user authentication processing (log-in processing) is performed, however, the processing is not limited thereto. In addition, with respect to user authentication, in a case where authentication information is input from the operation portion 60, the authentication information may be input as a character string together with a shortcut key by such as having decided the number of digits of the authentication information, or may be considered as a separate input. However, the authenticating portion 14 preferably employs a configuration in which user authentication is performed by an ID card such as an IC card and biometric authentication with finger prints or the like as illustrated more than any other configuration.

As illustrated as the processing at steps S35, S36, and S41, it is preferable that, in the image forming apparatus 1, when a number key (showing the output number in an image processing function) is input subsequent to inputting of the numeric key, image processing by the image processing function associated with the numeric key be repeated a repetition number shown by the number key (executed the output number). In addition, when such a number key is not input subsequent to inputting of the numeric key, image processing by the image processing function may be executed once. In this manner, minimum number of copies (one copy) is output by omitting inputting of the number of copies so that it is not troublesome even in a case where only one copy is desired to be output. Note that, here, for convenience, the number key is represented as a “number” key merely in order to distinguish from inputting of the “numeric key” as a shortcut key as to a type of an operation screen or a subsequent execution operation. In addition, the registration portion may include a setting portion for setting whether or not such association with the number of copies is performed.

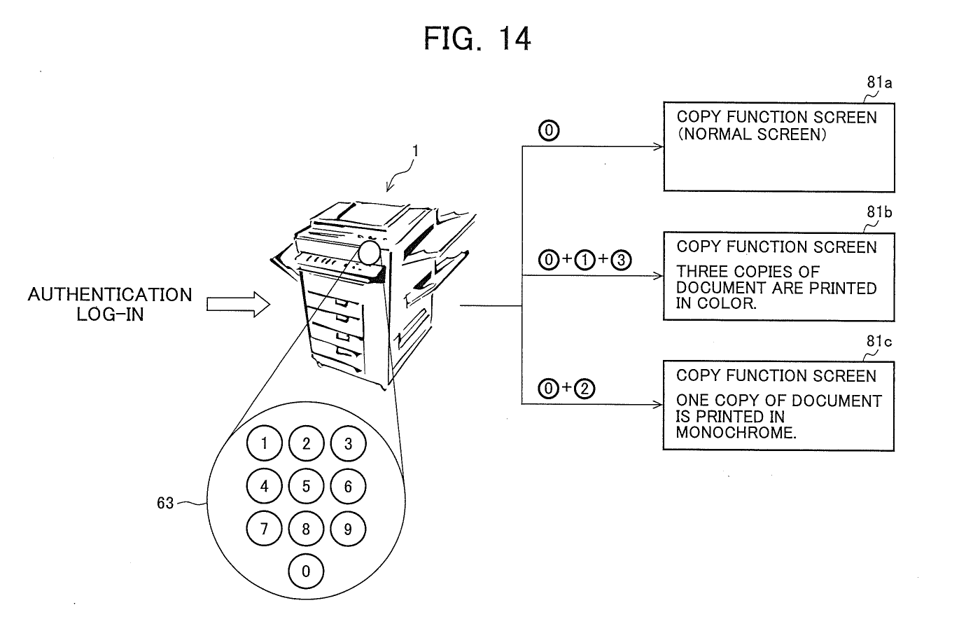

Next, description will be given for performance in the case of being associated in the previous explanation of the shortcut key registration with reference to FIGS. 14 to 17.

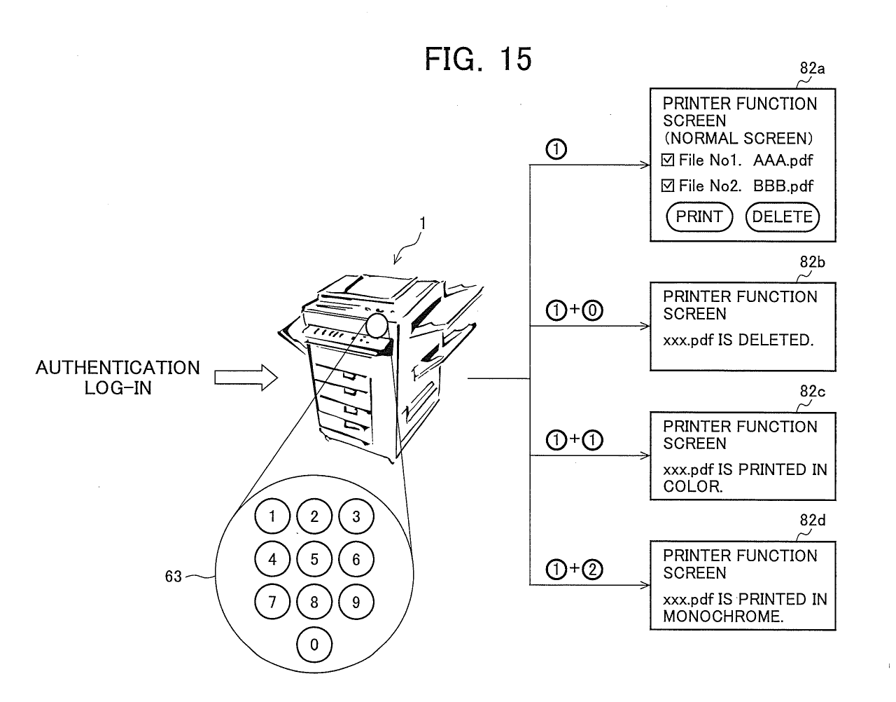

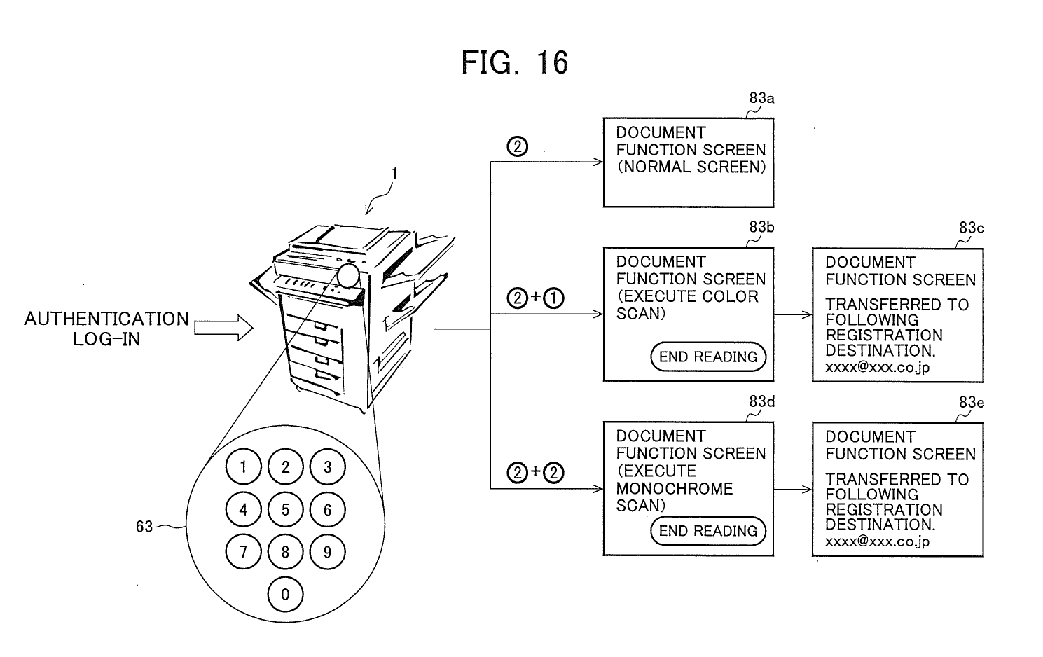

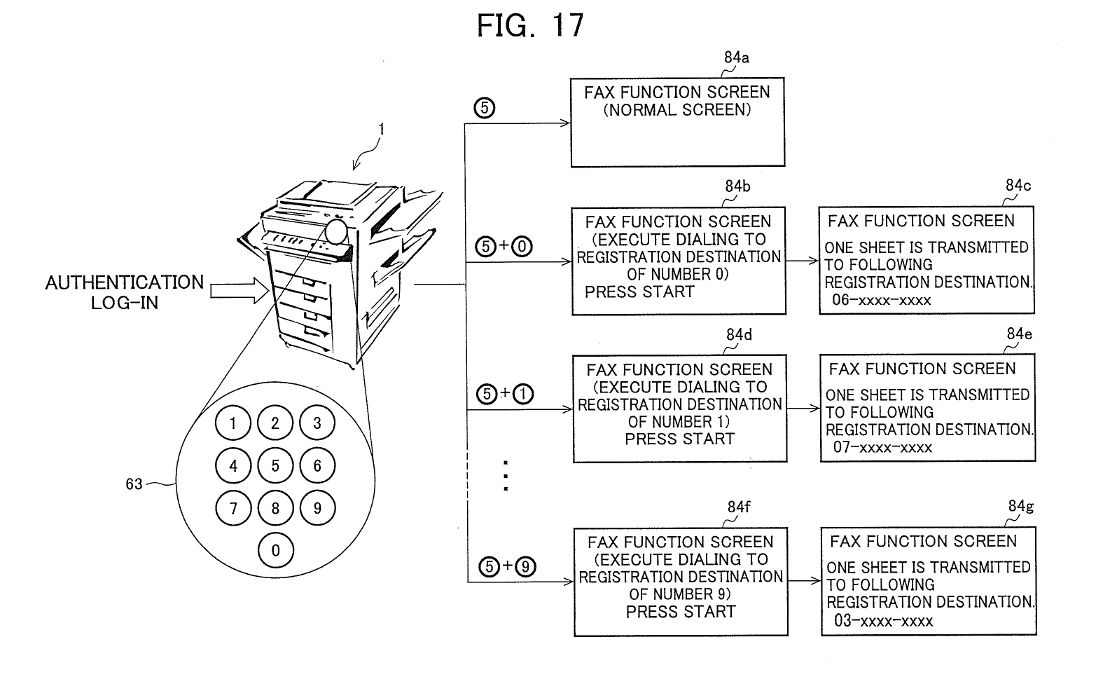

FIG. 14 is a conceptual view for explaining processing for moving to an operation screen of a copy function in the image forming apparatus of FIG. 2, FIG. 15 is a conceptual view for explaining processing for moving to an operation screen of a printer function in the image forming apparatus of FIG. 2, FIG. 16 is a conceptual view for explaining processing for moving to an operation screen of a document function in the image forming apparatus of FIG. 2, and FIG. 17 is a conceptual view for explaining processing for moving to an operation screen of a FAX function in the image forming apparatus of FIG. 2.

As shown in FIG. 14, as to the copy function, in the image forming apparatus 1, when a user presses a shortcut key by the hard key 63, and thereafter carries out user authentication (authentication log-in) by an ID card or biometric authentication with finger prints or the like, a function selection screen is not displayed but either of copy function screens 81a, 81b, or 81c is displayed directly. A case is assumed where the copy function is associated with a first shortcut key 0, color and monochrome are associated with second shortcut keys 1 and 2, respectively, in addition, image data read from the image reading portion is assumed to be copied, and a document thereof is set. Then, the number of copies is set by inputting third and subsequent numerical values, and when inputting is not performed (that is, omitted), one copy is made.

In a case where only “0” is input as a shortcut key, the normal copy function screen (operation screen as to the copy function) 81a is displayed, and an operation except therefor is not executed to wait for the next user operation. In a case where “013” is input as a shortcut key, three copies of color copy are executed, the copy function screen is displayed, and thereafter the copy function screen 81b showing completion of copying is displayed. In a case where “02” is input as a shortcut key, one copy of monochrome copy is executed, the copy function screen is displayed, and thereafter the copy function screen 81c showing completion of copying is displayed.

As shown in FIG. 15, as to the printer function, in the image forming apparatus 1, when a user presses a shortcut key by the hard key 63, and thereafter carries out user authentication (authentication log-in), a function selection screen is not displayed but either of printer function screens 82a, 82b, 82c, or 82d is displayed directly. A case is assumed where the printer function is associated with a first shortcut key 1, and deletion of a file, color, and monochrome are associated with second shortcut keys 0, 1, and 2, respectively. In addition, also in the printer function, similarly to the copy function, the number of copies is set by inputting third and subsequent numerical values, and when inputting is not performed, it may be configured so as to make one copy.

In a case where only “1” is input as a shortcut key, the normal printer function screen (operation screen as to the printer function) 82a is displayed, an operation except therefor is not executed to wait for the next user operation. Here, a case is assumed where what is to be printed is, for example, read from the image reading portion or read (received) from a USB memory, an external server, or a PC, and a file name which is read in this manner is also preferably displayed in the screen 82a. In a case where “10” is input as a shortcut key, the read file is deleted, the printer function screen is displayed, and thereafter the printer function screen 82b showing completion of deletion is displayed. In a case where “11” is input as a shortcut key, one copy of color printing is executed, the printer function screen is displayed, and thereafter the printer function screen 82c showing completion of printing is displayed. In a case where “12” is input as a shortcut key, one copy of monochrome printing is executed, the printer function screen is displayed, and thereafter the printer function screen 82d showing completion of printing is displayed.

As shown in FIG. 16, as to the document function, in the image forming apparatus 1, when a user presses a shortcut key by the hard key 63, and thereafter carries out user authentication (authentication log-in), a function selection screen is not displayed but either of document function screens 83a, 83b, or 83d is displayed directly. A case is assumed where the document function (E-mail transmission) is associated with a first shortcut key 2, color scan and monochrome scan are associated with second shortcut keys 1 and 2, respectively. In addition, image data read from the image reading portion is assumed to be transmitted by an E-mail, and a document thereof is set. In addition, one E-mail destination is registered, and moreover, detailed setting such as a resolution at the time of scanning or a file format is default or has been set in advance.

In a case where only “2” is input as a shortcut key, the normal document function screen (operation screen as to the document function) 83a is displayed, an operation except therefor is not executed to wait for the next user operation. In a case where “21” is input as a shortcut key, color scan is executed, the document function screen 83b including an end reading key is displayed, and with the end of scanning, a document function screen 83c showing that transmission has been performed is displayed. In a case where “22” is input as a shortcut key, monochrome scan is executed, the document function screen 83d including the end reading key is displayed, and with the end of scanning, a document function screen 83e showing that transmission has been performed is displayed. Here, it may be configured such that transmission is performed to an E-mail address of a registration destination at the time when the end reading key is pressed. Note that, when a separate document is set subsequently, a start button is pressed after the document is set to scan and read all the documents, and thereafter the end reading key may be pressed to transmit the E-mail.

In addition, when a case is assumed where a document function (USB saving) is associated with a first shortcut key 3, and color scan and monochrome scan are associated with second shortcut keys 1 and 2, respectively, for example, processing is performed in which color scan is performed with a shortcut key “31” to save the document in a USB memory. Also for a screen, a screen associated therewith is displayed. Here, when a separate document is set subsequently, the start button is pressed after the document is set to scan and read all the documents, and thereafter an end reading button may be pressed for saving.

In addition, when a case is assumed where a document function (HDD saving) is associated with a first shortcut key 4, and color scan and monochrome scan are associated with second shortcut keys 1 and 2, respectively, for example, processing is performed in which monochrome scan is performed with a shortcut key “42” to save the document in an HDD. Also for a screen, a screen associated therewith is displayed. A case where a separate document is set subsequently is the same as the case of the USB saving.

As shown in FIG. 17, as to the FAX function, in the image forming apparatus 1, when a user presses a shortcut key by the hard key 63, and thereafter carries out user authentication (authentication log-in), a function selection screen is not displayed but either of FAX function screens 84a, 84b, 84d, or 84f is displayed directly. A case is assumed where the FAX function is associated with a first shortcut key 5, and FAX numbers of registration destinations which are different from each other are associated with second shortcut keys 0 to 9, respectively. In addition, here, image data read from the image reading portion is assumed to be transmitted by FAX, and a document thereof is set.

In a case where only “5” is input as a shortcut key, the normal FAX function screen (operation screen as to the FAX function) 84a is displayed, and an operation except therefor is not executed to wait for the next user operation. In a case where “50” is input as a shortcut key, the FAX function screen 84b showing that dialing is performed to a registration destination of number 0 is displayed, and with the end of transmission, a FAX function screen 84c showing the transmission destination and that transmission has been performed is displayed. Similarly, in a case where “51” is input as a shortcut key, the FAX function screen 84d about a registration destination of number 1 is displayed, and with the end of transmission, a FAX function screen 84e showing the transmission destination and that transmission has been performed is displayed. Similarly, in a case where “59” is input as a shortcut key, the FAX function screen 84f about a registration destination of number 9 is displayed, and with the end of transmission, a FAX function screen 84g showing the transmission destination and that transmission has been performed is displayed. Note that, when transmission is not performed automatically after connection to the transmission destination and detection of a FAX signal, the start button may be pressed for transmission. In addition, in the case of FAX transmission, processing may be employed such that the processing is performed with a shortcut key until execution of dialing and the user needs to press the start button to start the FAX transmission.

As can be seen also from illustration in FIGS. 14 to 17, in the present invention, when an operation screen is displayed, with user authentication processing and an operation of the numeric key (hardware key and software key) on the operation panel, intervening operation screens are skipped and an operation screen desired by a user, that is associated with the numeric key, is displayed as well as the next operation in the desired operation screen is executed, so that it is possible to reduce the number of operations and the time required until execution.

According to the present invention, in the image processing apparatus having a plurality of image processing functions and capable of carrying out user authentication, the number of operations by a user is reduced by eliminating operations unnecessary for the user, so that it is possible to display an initial operation screen of a desired image processing function and execute image processing by the image processing function, and this makes it possible to improve user convenience.

1. An image processing apparatus having a plurality of image processing functions, comprising:
an operation portion capable of displaying an operation screen;
a user authenticating portion; and
a registration portion for registering, with respect to an operation screen of the image processing function displayed through inputting of a user operation, the operation screen and a numeric key input before or after user authentication processing by the user authenticating portion being associated with each other for each user who is able to be authenticated by the user authenticating portion, wherein
when the user authentication processing and inputting of the numeric key are performed, the operation screen, or a screen during execution or after execution of image processing by the image processing function is displayed as well as image processing by the image processing function is executed.

2. The image processing apparatus as defined in claim 1, wherein
when a number key is input subsequent to inputting of the numeric key, image processing by the image processing function associated with the numeric key is repeated a repetition number shown by the number key, and
when the number key is not input subsequent to inputting of the numeric key, image processing by the image processing function is executed once.
